(19) United States
(12) Patent Application Publication
(10) Pub. No.: US 2021/0157985 A1
(43) Pub. Date: May 27, 2021

(54) TROUBLESHOOTING ASSISTANT

(71) Applicants: AT&T Global Network Services (UK) B.V., Redditch (GB); AT&T Intellectual Property I, L.P., Atlanta, GA (US)

(72) Inventors: Gur Rotkop, Leamington Spa (GB); Sendhil Chokkalingam, Redmond, WA (US); Prasanna Ramachandran, Morganville, NJ (US)

(21) Appl. No.: 16/696,346

(22) Filed: Nov. 26, 2019

(51) Int. Cl. G06F 40/30; H04M 3/42; G06F 40/205

(52) U.S. Cl. CPC G06F 40/30; H04M 2201/40; G06F 40/205; H04M 3/42221

(57) ABSTRACT

In one example, a method performed by a processing system in a telecommunications network includes receiving a technical support query that reports a technical support issue, where the technical support query is phrased in natural language, parsing a meaning from the technical support query using natural language understanding, wherein the meaning indicates a nature of the technical support issue, matching the technical support query to a document stored in a dynamic knowledge base, wherein the matching is based on the meaning, identifying a remedial action to resolve the technical support issue, based on the document, and performing an action to carry out the remedial action.

The present disclosure relates generally to technical support, and relates more particularly to devices, non-transitory computer-readable media, and methods for troubleshooting based on a dynamic knowledge base.

### BACKGROUND

Technology service providers, such as Internet service providers (ISPs), application service providers (ASPs), cloud providers, and telecommunications service providers provider customers (e.g., enterprises and/or end users) with access to specialized, technology-oriented services. In addition to providing customers with access to these services, the technology service providers—or, alternatively, third parties—may provide technical support services. These technical support services may include providing troubleshooting, e.g., resolving specific problems with the services that the customers may experience.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of a method for providing technical support assistance, in accordance with the present disclosure;

FIG. 3 illustrates another flowchart of a method for providing technical support assistance, in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure performs technical support troubleshooting based on a dynamic knowledge base. In one example, a method performed by a processing system in a telecommunications network includes receiving a technical support query that reports a technical support issue, where the technical support query is phrased in natural language, parsing a meaning from the technical support query using natural language understanding, wherein the meaning indicates a nature of the technical support issue, matching the technical support query to a document stored in a dynamic knowledge base, wherein the matching is based on the meaning, identifying a remedial action to resolve the technical support issue, based on the document, and performing an action to carry out the remedial action.

In another example, a non-transitory computer-readable medium stores instructions which, when executed by a processing system in a telecommunications network, cause the processing system to perform operations. The operations include receiving a technical support query that reports a technical support issue, where the technical support query is phrased in natural language, parsing a meaning from the technical support query using natural language understanding, wherein the meaning indicates a nature of the technical support issue, matching the technical support query to a document stored in a dynamic knowledge base, wherein the matching is based on the meaning, identifying a remedial action to resolve the technical support issue, based on the document, and performing an action to carry out the remedial action.

In another example, a method performed by a processing system in a telecommunications network includes monitoring an action of a human technician who is performing a technical support task in the telecommunications network, detecting that a current action of the human technician is likely to trigger a fault in the telecommunications network, and generating an alert to halt the action of the human technician.

As discussed above, technology service providers may provide technical support services in addition to providing access to specialized, technology-oriented services. These technical support services may include providing troubleshooting, e.g., resolving specific problems with the services that the customers may experience. For instance, a customer of a cellular network service provider may notice that a particular application installed on his smart phone frequently crashes, or a customer of an Internet service provider (ISP) may notice that her laptop computer's Wi-Fi connection is unexpectedly slow.

However, quickly finding solutions to technical issues is not always a straightforward task. For one, a particular technical issue may be encountered many times in isolation before the issue is identified as a repeating problem and guidance on how to fix the problem is codified. Furthermore, even if documentation detailing how to resolve the technical issue is available, the documentation may be scattered across multiple storage locations, making it difficult for a technical support operator to gain access to all of the information needed to resolve the issue. Moreover, different customers may articulate the same technical issue in different ways; thus, even if all of the documentation needed to resolve an issue is available to an operator, the operator may not easily identify the documentation as being pertinent to the issue as articulated by the customer.

Examples of the present disclosure provide a troubleshooting assistant that has access to a plurality of natural language data sources relating to technical support. These natural language data sources may include both formal sources (e.g., vendor documents describing how to resolve specific technical issues, maintenance operation protocols, bug alerts, etc.) and informal sources (e.g., fault tickets, chat logs, telephone call transcripts, field alerts, etc.). A model that is specific to the domain of the technical service (e.g., Internet, cellular communications, etc.) may be used to parse meaning from a customer query that is phrased in natural language. The troubleshooting assistant may then use the parsed meaning to guide a search of the natural language data sources for the data that is most pertinent to the query, e.g., by searching based on meaning rather than on keyword match. Thus, the troubleshooting assistant may be able to efficiently identify and provide possible solutions to the technical issues reported by users.

Further examples of the present disclosure may enable automatic triage of reported technical issues on the technical support side. That is, the troubleshooting assistant may be able, based on understanding of the reported technical issues, to classify the reported technical issues according to their respective levels of urgency (e.g., which technical issues are most important to resolve first). Accordingly, more urgent technical issues can be automatically prioritized above less urgent issues.

According to further examples of the present disclosure, a troubleshooting assistant may learn how to resolve a recurring technical support issue by observing the remedial actions of human technicians and the effects of those remedial actions. The troubleshooting assistant may develop a workflow, based on these observations, that allows the troubleshooting assistant to autonomously (e.g., without intervention from a human technician) resolve future occurrences of the recurring technical support issue. Accordingly, the resources and attention of the human technicians can be directed to other issues that may be more complex or time consuming.

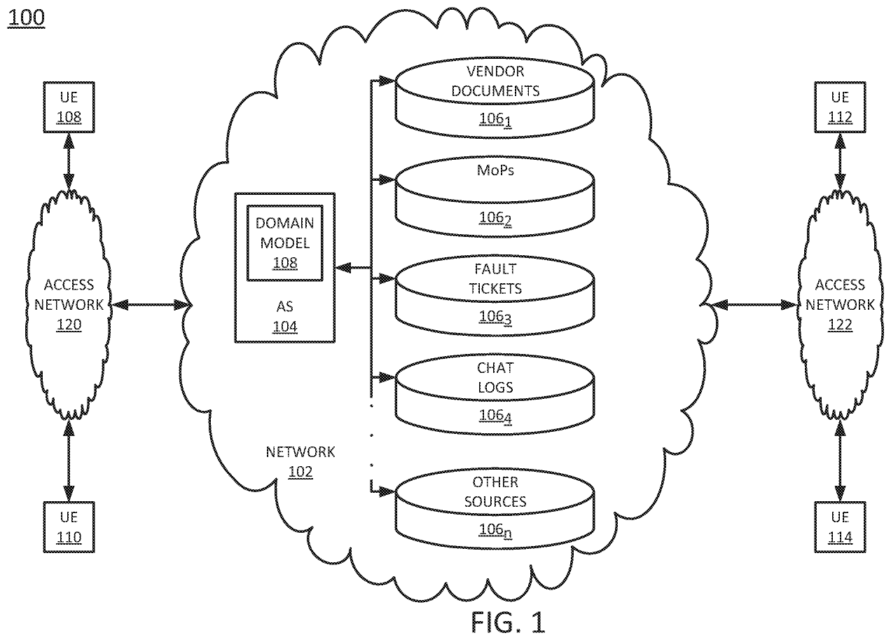

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

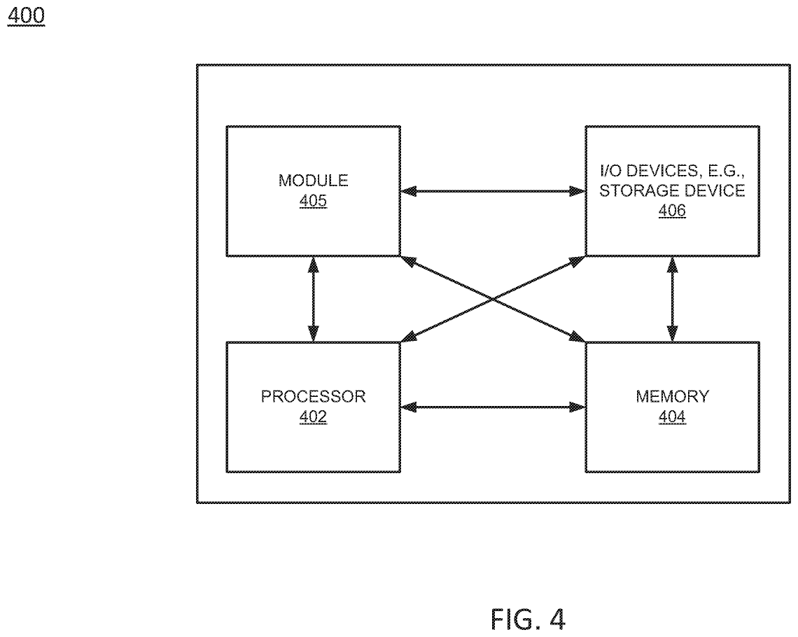

In accordance with the present disclosure, network 102 may include an application server (AS) 104, which may comprise a computing system or server, such as computing system 400 depicted in FIG. 4, and may be configured to provide one or more operations or functions in connection with examples of the present disclosure for providing technical support assistance. The network 102 may also include a plurality of databases 106₁-106ₙ (hereinafter individually referred to as a “database 106” or collectively referred to as “databases 106”) that are communicatively coupled to the AS 104 and that collectively form a dynamic knowledge base.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure. Thus, although only a single application server (AS) 104 and multiple databases are illustrated, it should be noted that any number of servers and databases may be deployed, and which may operate in a distributed and/or coordinated manner as a processing system to perform operations in connection with the present disclosure.

In one example, AS 104 may comprise a centralized network-based server for providing technical support assistance. For instance, the AS 104 may host an application that responds to technical support queries, e.g., by automatically suggesting and/or implementing remedial actions that are expected to resolve reported technical support issues (i.e., the problems that triggered the technical support queries). For instance, the application may parse incoming technical support queries that have been submitted in natural language form for information about reported technical support issues. The application may further prioritize the incoming technical support queries, so that the most urgent technical support queries can be expedited for resolution ahead of less urgent queries. The application may further match the incoming technical support queries to stored documents containing information that may help to resolve the reported technical support issues. The application may further take actions, either autonomously or through a human technician, to attempt a resolution of the reported technical support issues.

In still further examples, the application may learn workflows for resolving reported technical support issues by observing the actions of human technicians. The application may then be able to resolve future occurrences of the reported technical support issues autonomously. The application may also be able to assist the human technicians by detecting when the human technicians have entered commands or variables that are incorrect or that may be known to trigger faults, thereby giving the human technicians the opportunity to adjust their actions preemptively.

As discussed above, the application may make use of stored documents to assist in resolving technical support queries. In one example, AS 104 may comprise a physical storage device (e.g., a database server), to store these documents. In another examples, the databases 106 may store the documents, and the AS 104 may retrieve the documents from the databases 106 when needed. In one example, different types of documents may be stored in different databases. For instance, a first database 106₁ may store vendor documents (e.g., documents relating to the resolution of known technical support issues); a second database 1062 may store maintenance operation protocols (MoPs, e.g., protocols for uploading and downloading system software, remote testing, and problem diagnosis); a third database 106₃ may store fault tickets (e.g., tickets describing technical support issues that were encountered in the past and the efforts made to resolve the technical support issues, as well as tickets describing new, unresolved technical support issues); a fourth database 106₄ may store chat logs (e.g., transcripts of online chat sessions or conversations between technicians, between technicians and customers, and the like); and an nth database 106ₙ may store other data sources (e.g., telephone conversation transcripts, field alerts, etc.).

As discussed above, the databases 106 may collectively form a dynamic knowledge base. That is, the documents stored in the databases 106 may be continuously updated, augmented, and the like as new technical support queries are received and resolved. In addition, documents may be continuously added to any of the databases 106 to supplement the data that is already stored. For instance, new technical support issues may be encountered, new solutions to previously encountered technical support issues may be developed, and the like. Thus, the AS 104 may always have access to an up-to-date, dynamically changing base of knowledge.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, an edge server in one of the access networks 120 and/or 122 may be instantiated on one or more servers hosting virtualization platforms for managing one or more virtual machines (VMs), containers, microservices, or the like. In other words, in one example, the edge server may comprise a VM, a container, or the like.

In one example, the access network 120 may be in communication with one or more devices, e.g., user endpoint devices (UEs) 108 and 110. Similarly, access network 122 may be in communication with one or more devices, e.g., UEs 112 and 114. Access networks 120 and 122 may transmit and receive communications between UEs 108-114, application server (AS) 104, other components of network 102, devices reachable via the Internet in general, and so forth. In one example, any of the UEs 108-114 may comprise a computing device, such as a desktop computer, a laptop computer, a tablet computer, a mobile device, a cellular smart phone, a wearable computing device (e.g., smart glasses, a head mounted display, a smart watch, a fitness tracker, or the like), a gaming console, a set top box, an Internet of Things (IoT) device, or the like. In one example, any of the UEs 108-114 may comprise a computing system or device, such as computing system 400 depicted in FIG. 4, and may be configured to provide one or more operations or functions in connection with examples of the present disclosure for providing technical support assistance.

It should be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. Thus, these and other modifications are all contemplated within the scope of the present disclosure.

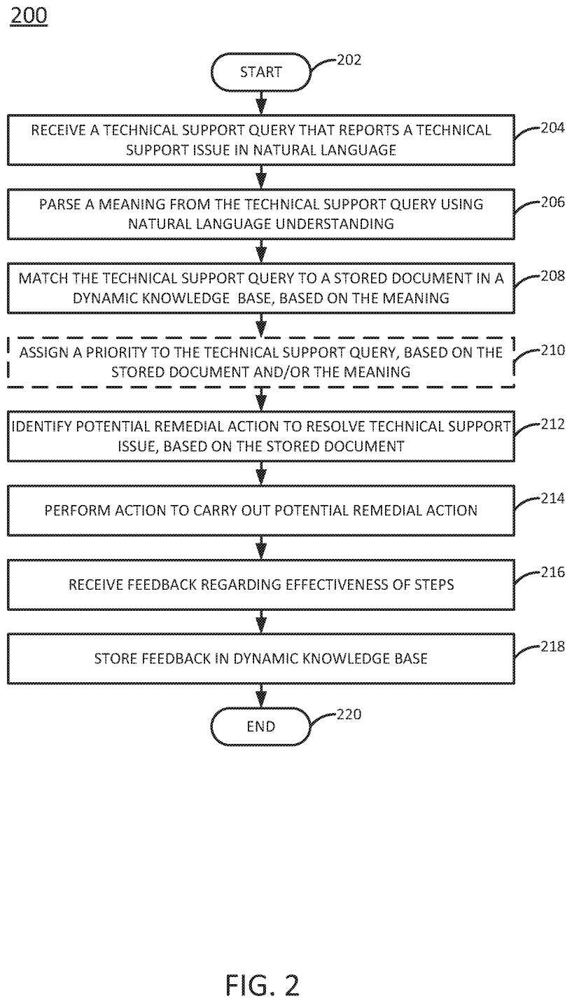

To further aid in understanding the present disclosure, FIG. 2 illustrates a flowchart of a method 200 for providing technical support assistance, in accordance with the present disclosure. In one example, the method 200 may be performed by an application server that is configured to accept technical support queries phrased in natural language and to search a dynamic knowledge base for possible resolutions to the queries, such as the AS 104 illustrated in FIG. 1. However, in other examples, the method 200 may be performed by another device, such as the processor 402 of the system 400 illustrated in FIG. 4. For the sake of example, the method 200 is described as being performed by a processing system.

The method 200 beings in step 202. In step 204, the processing system may receive a technical support query that is phrased in natural language. In one example, the technical support query may be received from a user endpoint device. For instance, the technical support query may be received in text form (e.g., via the user of the user endpoint device typing the query on a computer keyboard, a touch screen keypad of a smartphone or tablet, or the like), in audio form (e.g., via the user of the user endpoint device speaking the query into the handset of a smartphone or a landline telephone), in video form (e.g., via the user of the endpoint device signing the query in sign language to a video phone), or in any other form that allows the user to phrase the query in natural language. Within this context, “natural language” is understood to refer to language that has evolved naturally in human speech and conversation, e.g., through use and repetition and without conscious planning or premeditation. Thus, the query is phrased in a manner that is consistent with the way the user normally speaks, as opposed to respecting any formal syntax or structure that might make processing by a computer more straightforward. For instance, in one example, the user may be a customer of a cellular network service provider. In this case, the technical support query may comprise the statement, “My cell phone keeps crashing when I try to open Application X,” rather than, for instance, an error code.

In step 206, the processing system may parse a meaning from the technical support query, using natural language processing or understanding. That is, the processing system may identify, based on an analysis of the technical support query, the nature of the technical support issue being reported in the technical support query.

In one example, parsing of the meaning in accordance with step 206 may be facilitated using a domain-specific natural language understanding model. The domain-specific natural language understanding model may be tailored to a specific technology domain, e.g., associated with a specific technology service provider. For instance, the processing system may be part of a technical support system associated with a specific technology service provider, and the domain-specific natural language understanding model may be trained to interpret particular terms in a manner that is consistent with the domain of the specific technology service provider. As an example, a domain-specific natural language understanding model for an ISP might interpret the word “cookie” to refer to a piece of information that identifies a user throughout a session with a server, as opposed to a baked good that one might eat. Similarly, the same domain-specific natural language understanding model might interpret the word “firewall” to refer to a network security system that monitors incoming and outgoing network traffic, as opposed to a fire-resistant barrier that prevents the spread of fire in a building.

In step 208, the processing system may match the technical support query to at least one stored document in a dynamic knowledge base, based on the meaning parsed in step 206. In one example, the dynamic knowledge base may comprise a plurality of data sources that contain information relating to the resolution of technical support issues, where at least some of the data sources may be updated continuously with new information relating to new technical support issues as those new technical support issues are detected and resolved. For instance, in one example, the dynamic knowledge base may include at least one of the following data sources: vendor documents (e.g., documents relating to the resolution of known technical support issues), maintenance operation protocols (MoPs), fault tickets (e.g., tickets describing technical support issues that were encountered in the past and the efforts made to resolve the technical support issues), chat logs (e.g., transcripts of online chat sessions with technical support operators), telephone call transcripts, and/or field alerts.

In one example, the stored document(s) may be matched to the technical support query using metadata. For instance, the meaning parsed in step 206 may be matched to metadata associated with the stored document(s). As an example, the meaning parsed in step 206 may indicate that the user's mobile phone frequently drops voice calls. Thus, the dynamic knowledge base may be searched for stored documents whose metadata (e.g., tags) indicates that those documents are related to dropping mobile voice calls.

In optional step 210 (illustrated in phantom), the processing system may assign a priority to the technical support query. That is, the processing system may perform a form of triage in order to determine how urgent the technical support query is relative to other technical support queries that are pending. The triage may classify each incoming technical support query (e.g., high priority/medium priority/low priority, scale of one to ten, or any other classification scheme) so that more urgent technical support issues are dealt with sooner than less urgent technical support issues.

In one example, the urgency of the technical support query may be based at least in part on the contents of the stored documents that were matched to the technical support query in step 208. For instance, the urgency of the technical support query may be determined based on the occurrence of the reported technical support issue in the sources of the dynamic knowledge base.

As an example, the technical support query may comprise a syslog alert, and the processing system may further detect a traffic disruption in a communications network to which the processing system is connected. The processing system may perform an on-demand scan in order to identify the software versions of all components (e.g., operating system, hypervisor, virtual machines, virtual network functions, etc.) in the network stack. Subsequently (e.g., in step 208, discussed above), the processing system may match the software versions of the network stack components to a recent vendor-document bug (e.g., based on the equipment models and installed software versions observed in the scan matching the equipment models and installed software versions indicated in the vendor documentation). Furthermore, the vendor documentation may indicate that the bug may have a high level of impact on the performance of the communications network. Thus, the priority assigned to the technical support query may be relatively high.

In another example, the technical support query may comprise a simple network management protocol (SNMP) trap. A fault ticket associated with a previous network outage may indicate that an SNMP trap was the root cause of the previous network outage. The fault ticket may further indicate that the SNMP trap is likely to severely impact on the performance of the communications network. Thus, the priority assigned to the technical support query may be relatively high.

In another example, the technical support query may comprise an alarm, and the processing system may match the alarm to a previously received alarm in step 208. If the previously received alarm is listed as having been non-actionable, then the processing system may determine that the technical support query is also non-actionable (e.g., not urgent). Thus, the priority assigned to the technical support query may be relatively low. The processing system may even close the technical support query automatically in order to prevent the technical support query from being forwarded to a human technician.

In another example, the technical support query may comprise a minor alert; however, the processing system may determine, based on an analysis of incoming calls and self-generated tickets associated with a previous occurrence of the same reported technical support issue, that the previous occurrence generated a great deal of customer dissatisfaction. Thus, the processing system may determine that the technical support query is urgent based on likely customer impact. Thus, the priority assigned to the technical support query may be relatively high.

In another example, the urgency of the technical support query may be based at least in part on sentiment analysis of the technical support query. That is, in addition to identifying the nature of the technical support issue based on the phrasing of the technical support query (and potentially the domain) as discussed above, the processing system may also determine the nature of the technical support issues based on a sentiment detected in the technical support query. For instance, if the technical support query comprises an audible, spoken query, sentiment may be detected based on the sound or the volume of the user's voice (e.g., speaking more loudly may indicate that the user is agitated or that the technical support issue being reported is urgent or important to the user). Similarly, if the technical support query comprises a typed query, sentiment may be detected based on the speed of the typing, the touch pressure of the user's fingers on the keyboard or keypad, whether the user types the query in all capital letters, and/or the like (e.g., typing in all capitals may indicated that the user is agitated or that the technical support issue being reported is urgent or important to the user).

In step 212, when the processing system is ready to process the technical support query (e.g., based on the priority that may have been assigned in step 210), the processing system may identify a potential remedial action that is expected to resolve the reported technical support issue, based on the document(s) matched to the technical support query in step 208.

For instance, referring back to the SNMP trap example discussed above, the processing system may search open source chat room logs for reports of the same SNMP, where the forum log recommends a series of steps that is expected to resolve the technical support issue. The processing system may conclude that the recommended series of steps is likely to resolve the reported technical support issue.

In step 214, the processing system may perform an action to carry out the potential remedial action. In one example, the action may comprise sending an instruction to a human technician who is working on resolving the reported technical support issue, where the instruction includes steps to be carried out by the human technician to resolve the technical support issue.

In another example, the action may comprise autonomous steps performed by the processing system (e.g., without the assistance of a human technician) to resolve the technical support issue. In this example, the processing system may have learned the steps by observing one or more human technicians resolve a similar or the same technical support issue in the past. In this case, the processing system may send instructions to other devices that are affected by the reported technical support issue, where the instructions include steps to be carried out by those other devices (e.g., reboot), software to be installed by those other devices (e.g., patches), or other information that may help those other devices to resolve the reported technical support issue. Alternatively, the processing system may remotely configure a setting of one or more other devices to resolve the reported technical support issue.

For instance, the processing system may have determined, in step 208, that the reported technical support issue matches a “signature” of an observed technical support issue that is documented as having occurred many times in the past and that is detailed in one of the stored documents (e.g., the alarms generated, the hardware involved, and/or the impact on operations may match). The stored document detailing the observed technical support issue may also include a log that tracked how a human technician resolved the observed technical support issue when the observed technical support issue occurred in the past. If the observed technical support issue occurred many times in the past, and if the human technician in each instance applied the same series of steps to successfully resolve the observed technical support issue, then the series of steps may be considered a valid potential remedial action, and the processing system may carry out the series of steps autonomously (e.g., bypassing a human technician). In one example, the series of steps is flagged or otherwise indicated in the stored documents as a valid potential remedial action when the series of steps has been observed to have been successfully applied at least a threshold number of times in the past (where the threshold number of times may be configurable).

In another example, the processing system may have determined, in step 208, that the reported technical support issue does not exactly match the signature of any observed technical support issue that is documented as having occurred in the past. However, the reported technical support issue may share some similarities with an observed technical support issue (e.g., may share one of the alarms generated, the hardware involved, and/or the impact on operations). In this case, the processing system may autonomously carry out one or more steps of a series of steps that was performed to successfully resolve the observed technical support issue with which the reported technical support issue shares the similarities.

Thus, the processing system may learn, e.g., through observation and reinforcement learning, what steps or actions are likely to resolve a reported technical support issue. Thus, the processing system may apply the steps or actions autonomously, in order to resolve the reported technical support issue. This may relieve some of the burden on any human technicians, who may then be free to focus on other technical support issues whose resolutions may be more complex or time consuming.

In step 216, the processing system may receive feedback regarding the effectiveness of the steps carried out in step 214. In one example, the feedback may be explicit. For instance, the processing system may present an email or a dialog via a graphical user interface (GUI) of the user endpoint device of the user who submitted the technical support query, where the email or the dialog may ask the user whether the steps resolved the reported technical support issue. In another example, the feedback may be more implicit. For instance, if the technical support query comprises an automatically generated alarm, the processing system may detect that the alarm ceased after the steps were carried out in step 214. Alternatively, the processing system may detect that the technical support issue that triggered the alarm has been resolved (e.g., a device that lost connection to the network is now re-connected and communicating with the processing system).

In step 218, the processing system may store the feedback in the dynamic knowledge base. Thus, the feedback may be used to augment the information in the dynamic knowledge base, which may improve the processing system's responses to technical support queries in the future. For instance, the processing system may learn, via the feedback, how specific technical support issues can be resolved and how urgent specific technical support issues may be in different contexts.

The method 200 may end in step 220. However, the method 200 may be repeated for each technical support query that is received by the processing system.

It should be noted that although the method 200 describes resolving technical support queries that are phrased in natural language, the same or similar steps could be used to resolve queries that are not phrased in natural language. For instance, a technical support query may comprise an alarm or alert that is automatically generated by a device that is connected to the same network as the processing system. For instance, when a device experiences a failure or is disconnected from the network, the processing system may detect the failure or the disconnect (e.g., via the failed or disconnected device's failure to respond to a status inquiry) and may automatically generate an alarm. This alarm or alert may not be considered a “natural language” query; however, the problem that triggered the alarm or alert may be resolved in the manner outlined in FIG. 2.

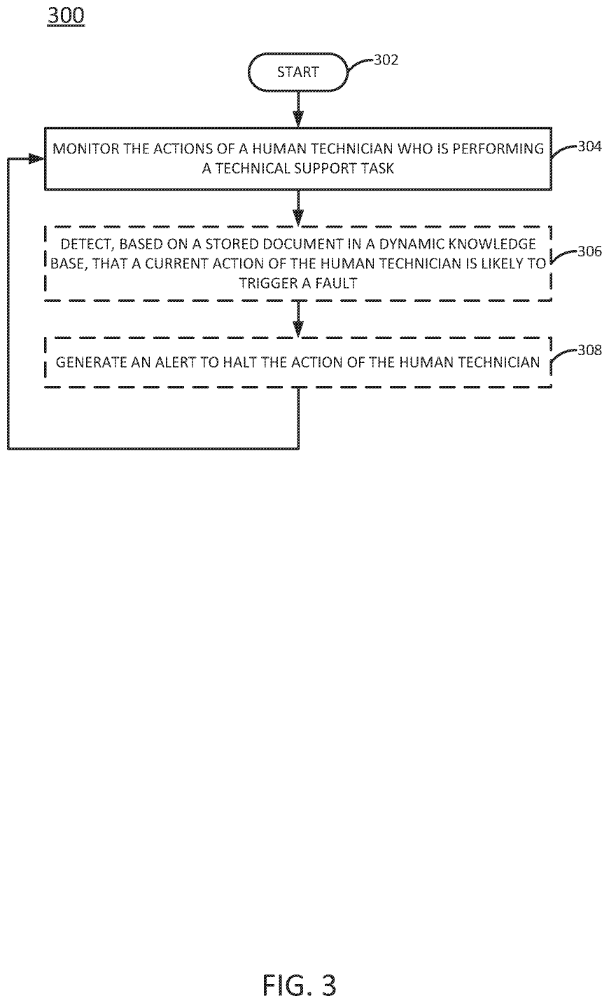

FIG. 3 illustrates a flowchart of a method 300 for providing technical support assistance, in accordance with the present disclosure. In one example, the method 300 may be performed by an application server that is configured to assist human technicians, such as the AS 104 illustrated in FIG. 1. However, in other examples, the method 300 may be performed by another device, such as the processor 402 of the system 400 illustrated in FIG. 4. For the sake of example, the method 300 is described as being performed by a processing system.

The method 300 beings in step 302. In step 304, the processing system may monitor the actions of a human technician who is performing a technical support task, in accordance with at least one stored document in a dynamic knowledge base. For instance, the human technician may be using a computing device to remotely program an item of live network equipment (e.g., configuring a prefix list for a router). The processing system may track the human technician's actions (e.g., commands executed, keystrokes, and/or the like) on the computing device while the item of live network equipment is being programmed.

The stored document in the dynamic knowledge base may describe a workflow for programming the item of live network equipment, as well as any problems that human technicians may have encountered in the past when programming the item of live network equipment or similar items of live network equipment. Thus, the processing system may track the human technician's actions with respect to the workflow described in the stored document (e.g., Is the human technician following the workflow? What point in the workflow do the human technician's current actions match?). In another example, the stored document may comprise a work order or a technical support ticket that has been assigned to the human technician, where the work order or technical support ticket specifies various attributes or variables for a task that the human technician is expected to carry out.

In optional step 306 (illustrated in phantom), the processing system may detect, based on information in the stored document, that a current action of the human technician is likely to trigger a fault. For instance, the human technician's current action may comprise configuring a command. The stored document may indicate that, in the past, when this command was executed on the same type of network equipment, performing the same role in the network, and running the same software, a fault was triggered. For instance, the command may be known by the equipment vendor to trigger a specific issue. Alternatively, referring to the above example of configuring a prefix list for a router, the processing system may detect, based on the attributes of a work order, that the human technician has entered the wrong subnet mask (in other words, the human technician has entered the right command, but the wrong attributes or variables for the command).

In optional step 308 (illustrated in phantom), the processing system may generate an alert to notify the human technician that a fault is likely to be triggered if the current action is carried out. For instance, the processing system may cause a dialog to be displayed via the GUI of the human technician's computing device. The dialog may indicate that a fault is likely to be triggered and may ask the human technician if he or she wishes to continue with the current action. In one example, the dialog may present details of the fault that is likely to be triggered or of the specific action that is likely to trigger the fault. For instance, continuing the above example of the prefix list, the dialog may ask the human technician to double check the subnet mask that was entered. Alternatively, the dialog may indicate that execution of a specific command on the equipment being configured is likely to cause a service outage.

Once the human technician has acknowledged the alert (e.g., by closing the alert, selecting a yes/no option, or the like), the method 300 may return to step 304, and the processing system may continue to monitor the actions of the human technician. Thus, the method 300 may continue to iterate through steps 304-308 until the technical support task is completed.

Although not expressly specified above, one or more steps of the method 200 or 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or 300 may be implemented as the system 400. For instance, a server (such as might be used to perform the method 200 or 300) could be implemented as illustrated in FIG. 4.

As depicted in FIG. 4, the system 400 comprises a hardware processor element 402, a memory 404, a module 405 for providing technical support assistance, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for providing technical support assistance may include circuitry and/or logic for performing special purpose functions relating to the operation of a home gateway or AR server. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for providing technical support assistance (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for providing technical support assistance (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
receiving, by a processing system in a telecommunications network, a technical support query that reports a technical support issue, where the technical support query is phrased in natural language;
parsing, by the processing system, a meaning from the technical support query using natural language understanding, wherein the meaning indicates a nature of the technical support issue;
matching, by the processing system, the technical support query to a document stored in a dynamic knowledge base, wherein the matching is based on the meaning;
identifying, by the processing system, a remedial action to resolve the technical support issue, based on the document; and
performing, by the processing system, an action to carry out the remedial action.

2. The method of claim 1, wherein the parsing is performed using a natural language understanding model that is specific to a technical domain of the technical support query.

3. The method of claim 1, wherein the performing comprises:
sending, by the processing system, an instruction to a human technician who is working on resolving the technical support query, wherein the instruction includes steps to be carried out by the human technician.

4. The method of claim 1, wherein the performing comprises:
sending, by the processing system, an instruction to a device in the telecommunications network that is affected by the technical support issue, wherein the instruction includes steps to be carried out by the device.

5. The method of claim 4, wherein the instruction further includes software to be downloaded by the device.

6. The method of claim 1, wherein the performing comprises:
remotely configuring, by the processing system, a setting of a device in the telecommunications network that is affected by the technical support issue.

7. The method of claim 1, further comprising:
assigning, by the processing system and prior to the performing, a priority to the technical support query, wherein the priority indicates an urgency of the technical support query relative to a plurality of other technical support queries received by the processing system.

8. The method of claim 7, wherein the priority is based in part on a sentiment analysis of the technical support query, where the sentiment indicates a likely impact of the technical support issue on customer satisfaction.

9. The method of claim 7, wherein the priority is based in part information contained in the document, where the information indicates a likely impact of the technical support issue on customer satisfaction.

10. The method of claim 7, wherein the priority is based in part information contained in the document, where the information indicates a likely impact of the technical support issue on a performance of the telecommunications network.

11. The method of claim 1, wherein the document is a vendor document describing how to resolve the technical support issue.

12. The method of claim 1, wherein the document is a maintenance operation protocol.

13. The method of claim 1, wherein the document is a fault ticket describing a previous technical support issue that was encountered in the past and an effort made to resolve the previous technical support issue.

14. The method of claim 1, wherein the document is a transcript of a conversation between a human technician and a customer, where the conversation related to a previous technical support issue encountered in the past.

15. The method of claim 1, further comprising:
receiving, by the processing system, feedback regarding whether the technical support issue was successfully resolved; and
storing, by the processing system, the feedback in the dynamic knowledge base.

16. A non-transitory computer-readable medium storing instructions which, when executed by a processing system in a telecommunications network, cause the processing system to perform operations, the operations comprising:
receiving a technical support query that reports a technical support issue, where the technical support query is phrased in natural language;
parsing a meaning from the technical support query using natural language understanding, wherein the meaning indicates a nature of the technical support issue;
matching the technical support query to a document stored in a dynamic knowledge base, wherein the matching is based on the meaning;
identifying a remedial action to resolve the technical support issue, based on the document; and
performing an action to carry out the remedial action.

17. A method, comprising:
monitoring, by a processing system in a telecommunications network, an action of a human technician who is performing a technical support task in the telecommunications network;
detecting, based on a stored document retrieved from a dynamic knowledge base, that a current action of the human technician is likely to trigger a fault in the telecommunications network; and
generating, by the processing system, an alert to halt the action of the human technician.

18. The method of claim 17, wherein the document comprises a workflow for performing a technical support task.

19. The method of claim 17, wherein the action comprises configuring a command for a device in the telecommunications network.

20. The method of claim 17, wherein the action comprises entering an incorrect attribute for a command for a device in the telecommunications network.
